(19) United States
(12) Patent Application Publication
(10) Pub. No.: US 2025/0320654 A1
(43) Pub. Date: Oct. 16, 2025

(54) WASHING MACHINE

(71) Applicant: SAMSUNG ELECTRONICS CO., LTD., Suwon-si (KR)

(72) Inventors: Yongwoo NAM, Suwon-si (KR); Jeongyun LEE, Suwon-si (KR); Hwangmook CHO, Suwon-si (KR); Byoungyull YANG, Suwon-si (KR); Shunichi OSADA, Suwon-si (KR)

(73) Assignee: SAMSUNG ELECTRONICS CO., LTD., Suwon-si (KR)

(21) Appl. No.: 19/183,498

(22) Filed: Apr. 18, 2025

Related U.S. Application Data
(63) Continuation of application No. PCT/KR2025/004669, filed on Apr. 7, 2025.

(30) Foreign Application Priority Data
Apr. 16, 2024 (KR) 10-2024-0051018

(51) Int. Cl. D06F 43/02; H02K 5/10; H02K 7/08; H02K 21/16

(52) U.S. Cl. CPC D06F 43/02; H02K 5/10; H02K 7/083; H02K 21/16

(57) ABSTRACT

A washing machine may include: a washing tub forming a sealable internal space in which carbon dioxide is receivable and configured so that, with the carbon dioxide received in the internal space and the internal space sealed, a pressure of the carbon dioxide is maintained, a rotatable drum in the internal space and configured to accommodate laundry to be washed with the received carbon dioxide, a rotatable shaft in the internal space and connected to the drum, and a drive device including: a stator outside the washing tub, and a rotor in the internal space, coupled to the shaft, and configured so that, with the carbon dioxide received in the internal space and the internal space sealed, electromagnetic interaction between the rotor and the stator causes the rotor to rotate thereby rotating the shaft and the drum to wash the laundry accommodated in the drum with the received carbon dioxide.

### CROSS-REFERENCE TO RELATED APPLICATIONS

This is a continuation application, under 35 U.S.C. § 111(a), of International Application No. PCT/KR2025/004669, filed Apr. 7, 2025, which claims priority under 35 U.S.C. § 119 to Korean Patent Application No. 10-2024-0051018, filed Apr. 16, 2024, in the Korean Intellectual Property Office, the disclosures of which are incorporated herein in their entireties by reference.

### TECHNICAL FIELD

The disclosure relates to a washing machine.

### BACKGROUND ART

In general, washing machines are devices that use water as a solvent to wash laundry. In contrast, dry cleaning washing machines use a volatile organic compound instead of water as a laundry solvent to wash laundry without water. The dry cleaning washing machines may use solvent-based, petroleum-based laundry solvents, and the like.

Washing machines that use water may generate wastewater during the washing process and pollute the environment, while solvent-based and petroleum-based laundry solvents used in dry cleaning washing machines may be harmful to the human body and pollute the environment.

Carbon dioxide may be used as a laundry solvent to replace the laundry solvent described above. Carbon dioxide has a lower viscosity than water, so it may easily penetrate between fibers and remove contaminants. After the washing process, the carbon dioxide containing foreign substances may be evaporated to separate the carbon dioxide and the foreign substances, and the evaporated carbon dioxide may be reused.

Carbon dioxide is one of the common components of the atmosphere, and thus it does not pollute the environment. In addition, liquid carbon dioxide may be evaporated and liquefied for reuse, so it does not produce much carbon dioxide, which may also contribute to achieving carbon neutrality.

### DISCLOSURE

### Technical Problem

An embodiment of the present disclosure provides a washing machine in which a shaft does not penetrate a washing tub, by arranging a rotor inside the washing tub, which is a pressure vessel, and a stator outside the washing tub.

An embodiment of the present disclosure provides a washing machine in which a shaft does not penetrate a washing tub, which is a pressure vessel, thereby eliminating the need for a mechanical seal to seal between the shaft and a through hole of the washing tub.

An embodiment of the present disclosure provides a washing machine having improved stability due to the absence of a hole penetrating a washing tub, which is a pressure vessel.

Technical tasks to be achieved in this document are not limited to the technical tasks mentioned above, and other technical tasks not mentioned will be clearly understood by those skilled in the art from the description below.

### Technical Solution

In accordance with the present disclosure, a washing machine may include: a washing tub forming a sealable internal space in which carbon dioxide is receivable and configured so that, with the carbon dioxide received in the internal space and the internal space sealed, a pressure of the carbon dioxide is maintained, a rotatable drum in the internal space and configured to accommodate laundry to be washed with the received carbon dioxide, a rotatable shaft in the internal space and connected to the drum, and a drive device including: a stator outside the washing tub, and a rotor in the internal space, coupled to the shaft, and configured so that, with the carbon dioxide received in the internal space and the internal space sealed, electromagnetic interaction between the rotor and the stator causes the rotor to rotate thereby rotating the shaft and the drum to wash the laundry accommodated in the drum with the received carbon.

Opposite ends of the shaft may be within the internal space so that the shaft does not penetrate through the washing tub.

A first end of the shaft may be connected to the drum, and a second end of the shaft may be within the washing tub.

The washing tub may include: a drum receiving portion configured to receive the drum, and a rotor receiving portion in which the rotor and at least a portion of the shaft is received, and having a first side that may be open and connected to the drum receiving portion and a second side that may be closed.

The washing machine may further include: a bearing within the rotor receiving portion and rotatably supporting the shaft.

The bearing may include: a first bearing that may be adjacent to the first side of the rotor receiving portion and between the rotor and the drum, and a second bearing that may be adjacent to the second side of the rotor receiving portion and between the second side of the rotor receiving portion and the rotor.

The stator may contact an outer surface of the rotor receiving portion so that a gap between the rotor and the stator in a direction perpendicular to a direction in which the shaft extends may be reduced.

The rotor may be spaced apart from the rotor receiving portion by a predetermined gap in the direction perpendicular to the direction in which the shaft extends so that the rotor may be prevented from contacting an inner surface of the rotor receiving portion as the rotor is rotated.

The washing tub may include: a first washing tub body forming the drum receiving portion, and a second washing tub body forming the rotor receiving portion, and the first washing tub body and the second washing tub body may be coupled by a fastening member to form the washing tub.

The first washing tub body may include a first flange protruding radially from the first washing tub body and including a first fastening hole, and the second washing tub body may include a second flange protruding radially from the second washing tub body and including a second fastening hole corresponding to the first fastening hole, and the fastening member may penetrate the first fastening hole and the second fastening hole in a direction parallel to the direction in which the shaft extends to thereby couple the first washing tub body and the second washing tub body.

The washing machine may further comprise: a sealing member between the first flange and the second flange and providing a seal between the first washing tub body and the second washing tub body.

The sealing member may extend along a circumferential direction of the first washing tub body and/or the second washing tub body, and a distance from the shaft to the sealing member in a direction perpendicular to a direction in which the shaft extends may be shorter than a distance from the shaft to the fastening member in the direction perpendicular to the direction in which the shaft extends.

The rotor may include a plurality of magnets spaced apart from each other along a circumferential direction of the shaft, and each magnet of the plurality of magnets may include neodymium (Nd).

The washing tub may include stainless steel (SUS).

### DESCRIPTION OF DRAWINGS

FIG. 1 is a conceptual diagram to illustrate a flow of carbon dioxide in a washing machine according to an embodiment.

FIG. 2 is a view illustrating a washing tub, a drum, and a drive unit in the washing machine according to an embodiment.

FIG. 3 is an exploded view of the washing tub, the drum, and the drive unit in the washing machine according to an embodiment.

FIG. 4 illustrates an example of a cross-section taken along A-A′ of FIG. 2.

FIG. 5 illustrates an example of a drive device in a washing machine according to an embodiment.

FIG. 6 is an exploded view of the drive device shown in FIG. 5.

FIG. 7 illustrates an example of a cross-section taken along B-B′ of FIG. 2.

FIG. 8 illustrates an example of a cross-section taken along B-B′ of FIG. 2.

### DETAILED DESCRIPTION

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

A singular expression may include a plural expression unless otherwise indicated herein or clearly contradicted by context.

The expressions “A or B”, “at least one of A or/and B”, or “one or more of A or/and B”, “A, B or C”, “at least one of A, B or/and C”, or “one or more of A, B or/and C”, and the like used herein may include any and all combinations of one or more of the associated listed items.

The term of “and/or” includes a plurality of combinations of relevant items or any one item among a plurality of relevant items.

Herein, the expressions “a first”, “a second”, “primary”, “secondary”, etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

The terms “including”, “having”, and the like are used to specify features, numbers, steps, operations, elements, components, or combinations thereof, but do not preclude the presence or addition of one or more of the features, figures, steps, operations, elements, components, or combinations thereof.

When an element is said to be “connected”, “coupled”, “supported” or “contacted” with another element, this includes not only when elements are directly connected, coupled, supported or contacted, but also when elements are indirectly connected, coupled, supported or contacted through a third element.

Throughout the description, when an element is “on” another element, this includes not only when the element is in contact with the other element, but also when there is another element between the two elements.

A washing machine according to various embodiments may include a housing accommodating a number of components therein. The housing may be arranged in the form of a box with an inlet for laundry on one side thereof.

The washing machine may include a door to open or close the laundry inlet. The door may be rotatably mounted to the housing by a hinge. At least a portion of the door may be configured to be transparent or translucent to allow the interior of the housing to be visible.

The washing machine may include a drum provided to accommodate laundry.

The drum may rotate within the housing to perform each of a washing, rinsing, and spin-drying processes. A plurality of through holes may be formed in a cylindrical wall of the drum.

The washing machine may include a drive device configured to rotate the drum. The drive device may include a drive motor and a rotating shaft for transmitting a rotational force generated by the drive motor to the drum.

The drive device may be configured to rotate the drum in a forward or reverse direction to perform the respective operations according to the washing and rinsing processes.

The washing machine may include a control panel disposed on one side of the housing. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output through a screen, an indicator, or voice. The at least one output interface may include a Liquid Crystal Display (LCD) panel, a Light Emitting Diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between external devices, and support the performance of the communication through the established communication channel. According to one embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or WAN). These various types of communication modules may be integrated as one component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an infrared data association (IrDA) communication module, a Wi-Fi Direct (WFD) communication module, an ultrawideband (UWB) communication module, an Ant+ communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server on a mobile communication network.

According to one embodiment, the communication module may communicate with an external device such as a server, a user device and other home appliances through an access point (AP). The access point (AP) may connect a local area network (LAN), to which a washing machine or a user device is connected, to a wide area network (WAN) to which a server is connected. The washing machine or the user device may be connected to the server through the wide area network (WAN). The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to regulate the rotational speed of the drum.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

Hereinafter, various embodiments according to the disclosure will be described in detail with reference to the accompanying drawings.

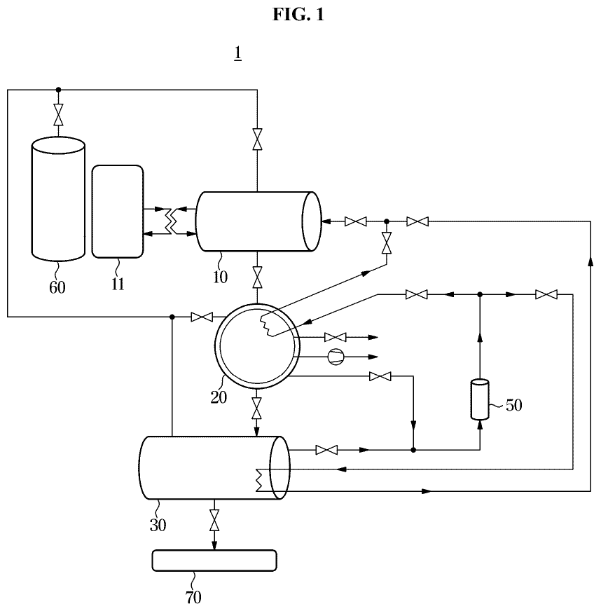

FIG. 1 is a conceptual diagram for explaining a flow of carbon dioxide in a washing machine according to an embodiment.

Referring to FIG. 1, a washing machine 1 according to an embodiment may include a storage tank 10 configured to store carbon dioxide, a washing tub 20 configured to perform washing therein using carbon dioxide, a distillation tank 30 configured to accommodate carbon dioxide and foreign matter discharged from the washing tub 20, a foreign matter tank 70 configured to store and discharge foreign matter discharged from the distillation tank 30, a compressor 50 configured to compress and move carbon dioxide, and a chiller 11 configured to cool the storage tank 10. The washing machine 1 may further include a supplement tank 60 configured to supplement carbon dioxide lost in the process of recovering carbon dioxide after washing.

The storage tank 10 may be configured to store carbon dioxide. The storage tank 10 may be configured to store gaseous carbon dioxide and liquid carbon dioxide. The storage tank 10 may maintain an internal pressure above a predetermined pressure so as to store liquid carbon dioxide.

The storage tank 10 may include a first outlet configured to discharge gaseous carbon dioxide and a second outlet configured to discharge liquid carbon dioxide. The storage tank 10 may include an inlet through which gaseous carbon dioxide is introduced from the outside. The first outlet may be formed at a higher position than the second outlet so that liquid carbon dioxide inside the storage tank 10 is not discharged through the first outlet. The inlet may be formed at a higher position than the second outlet so that liquid carbon dioxide inside the storage tank 10 is not discharged through the inlet. For example, the first outlet and the inlet may be formed at a position higher than the high liquid level of liquid carbon dioxide stored in the storage tank 10.

The chiller 11 may be configured to cool the storage tank 10. The chiller 11 may liquefy the gaseous carbon dioxide inside the storage tank 10 by cooling the storage tank 10. Accordingly, the gaseous carbon dioxide recovered from the washing tub 20 and the distillation tank 30 may be liquefied. The liquefied carbon dioxide may be discharged from the storage tank 10 back into the washing tub 20 and used for washing. The chiller 11 may liquefy the recovered carbon dioxide in a gaseous state, thereby allowing the carbon dioxide to circulate between the storage tank 10, the washing tub 20, and the distillation tank 30. The chiller 11 may include an evaporator of a heat pump. Alternatively, the chiller 11 may include at least one of various types of cooling devices.

The washing tub 20 may provide a space for washing laundry using liquid carbon dioxide as a washing solvent. The washing tub 20 may store liquid carbon dioxide and gaseous carbon dioxide therein. The washing tub 20 may have an internal pressure maintained above a predetermined pressure to allow the liquid carbon dioxide to be stored therein. For example, the internal pressure of the washing tub 20 may be maintained at approximately 30 to 60 bar. To allow the internal pressure to be maintained at approximately 30 to 60 bar, the washing tub 20 may have a sealed internal space.

A drum 40 may be disposed within the washing tub 20. The drum 40 may be rotated inside the washing tub 20 by a rotational force of a drive device 100, which will be described later. Laundry may be loaded into the drum 40. Liquid carbon dioxide may be flow into or out of the interior of the drum 40 through a plurality of drum holes 41 formed in the drum 40, and may be used as a laundry solvent as described above. Laundry loaded inside the drum 40 may be washed by the liquid carbon dioxide and detergent in response to rotation of the drum 40.

The washing tub 20 may be positioned lower than the storage tank 10. As the washing tub 20 is positioned lower than the storage tank 10, the liquid carbon dioxide stored in the storage tank 10 may be transferred from the storage tank 10 to the washing tub 20 by gravity without power.

During the process of loading laundry into the drum 40 within the washing tub 20, air may be introduced into the washing tub 20. In response to air being introduced into the washing tub 20, moisture contained in the air may condense during the process of reducing the pressure inside the washing tub 20 after the washing is completed. When moisture introduced into the laundry condenses between the laundry, the laundry may be damaged. To prevent such a situation, the washing machine 1 may include a vacuum pump configured to discharge air inside the washing tub 20.

The distillation tank 30 may be configured to receive carbon dioxide and foreign matter discharged from the washing tub 20 after washing. In particular, the distillation tank 30 may receive liquid carbon dioxide, foreign matter dissolved or not dissolved in the liquid carbon dioxide, and gaseous carbon dioxide discharged from the washing tub 20.

The washing machine 1 may recover carbon dioxide inside the distillation tank 30 to the storage tank 10. The gaseous carbon dioxide inside the distillation tank 30 may be moved to the storage tank 10 by the compressor 50. The liquid carbon dioxide inside the distillation tank 30 may be evaporated by heat applied to the distillation tank 30. The evaporated carbon dioxide may be moved to the storage tank 10 by the compressor 50. As the liquid carbon dioxide evaporates, foreign matter dissolved in the liquid carbon dioxide may be separated from the liquid carbon dioxide. The foreign matter in the distillation tank 30 may be discharged into the foreign matter tank 70 after the gaseous carbon dioxide is returned to the storage tank 10.

In the above process, the gaseous carbon dioxide discharged from the distillation tank 30 may become a gas of high-temperature and high-pressure as it passes through the compressor 50. The gaseous carbon dioxide, whose temperature is increased by passing through the compressor 50, may exchange heat with the distillation tank 30 to provide heat to the interior of the distillation tank 30. During the process of recovering the carbon dioxide inside the distillation tank 30 to the storage tank 10, heat may be generated by the compressor 50, and by supplying such heat to the distillation tank 30, the liquid carbon dioxide inside the distillation tank 30 may be evaporated. According to an embodiment, the heat generated by the compressor 50 may be supplied to the distillation tank 30 as described above without including a separate heat source such as a heater.

The foreign matter tank 70 may be configured to store foreign matters discharged from the distillation tank 30. A user may discharge the foreign matters stored in the foreign matter tank 70 at appropriate intervals. The frequency of emptying the foreign matter tank 70 may vary depending on the capacity of the foreign matter tank 70 and the amount of foreign matter contained in the laundry.

The supplement tank 60 may be configured to supplement carbon dioxide that is lost during the process of recovering carbon dioxide after washing. The supplement tank 60 may be configured to store carbon dioxide therein. The supplement tank 60 may supply carbon dioxide to the storage tank 10 or the washing tub 20. The supplement tank 60 may be arranged to be detachable from the washing machine 1. The supplement tank 60 may be configured to be replaceable with another supplement tank 60. Alternatively, the supplement tank 60 may be arranged to be detachable from the washing machine 1, to replenish its interior with carbon dioxide, and to be recoupled to the washing machine 1. The pressure inside the supplement tank 60 may be arranged to be higher than the pressure inside the washing tub 20.

The washing machine 1 may include a valve arranged on a flow path through which carbon dioxide moves. The flow path may include a gas flow path through which gaseous carbon dioxide predominantly moves and a liquid flow path through which liquid carbon dioxide predominantly moves. The valve may include a gas valve configured to open and close the gas flow path through which gaseous carbon dioxide predominantly moves. The valve may include a liquid valve configured to open and close the liquid flow path through which liquid carbon dioxide predominantly moves. The washing machine 1 may include a flow path connection in which a plurality of flow paths merge into a single flow path or a single flow path branches into a plurality of flow paths.

The washing machine 1 may recover carbon dioxide discharged from the washing tub 20 to the distillation tank 30 to the storage tank 10.

The washing machine 1 may recover gaseous carbon dioxide inside the distillation tank 30 to the storage tank 10 or may evaporate liquid carbon dioxide inside the distillation tank 30 and then recover the evaporated liquid carbon dioxide to the storage tank 10.

The washing machine 1 may include a flow path connecting the distillation tank 30 and an inlet end of the compressor 50, and a valve for opening or closing the flow path.

The carbon dioxide discharged from the compressor 50 may be via the interior of the distillation tank 30 or may be via the exterior of the distillation tank 30 adjacent to the distillation tank 30. The carbon dioxide, the temperature of which is increased as it passes through the compressor 50, may supply heat to the distillation tank 30 through a pipe passing through the distillation tank 30.

The distillation tank 30 may discharge foreign matter separated from carbon dioxide into the foreign matter tank 70. Foreign matter separated from carbon dioxide in the distillation tank 30 may be discharged to the foreign matter tank 70 by opening a valve disposed between the distillation tank 30 and the foreign matter tank 70.

A depressurization process may be included for depressurizing the interior of the washing tub 20 in order to take out the laundry from the washing tub 20 after the washing is completed.

The depressurization process may refer to a process of reducing the pressure inside the washing tub 20 to 1 to 1.5 bar, which is similar to the atmospheric pressure. The depressurization process may be a process of reducing the pressure inside the washing tub 20 by returning the carbon dioxide inside the washing tub 20 to the storage tank 10.

The washing machine 1 may include a flow path connecting the washing tub 20 and the inlet end of the compressor 50, and a valve for opening or closing the flow path. The carbon dioxide discharged from the compressor 50 may be via the interior of the washing tub 20 or the exterior of the washing tub 20 adjacent to the washing tub 20. The carbon dioxide, the temperature of which is increased as it passes through the compressor 50, may supply heat to the washing tub 20 through a pipe passing through the washing tub 20.

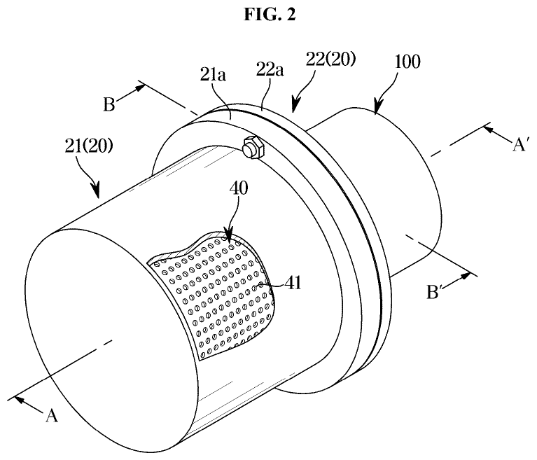

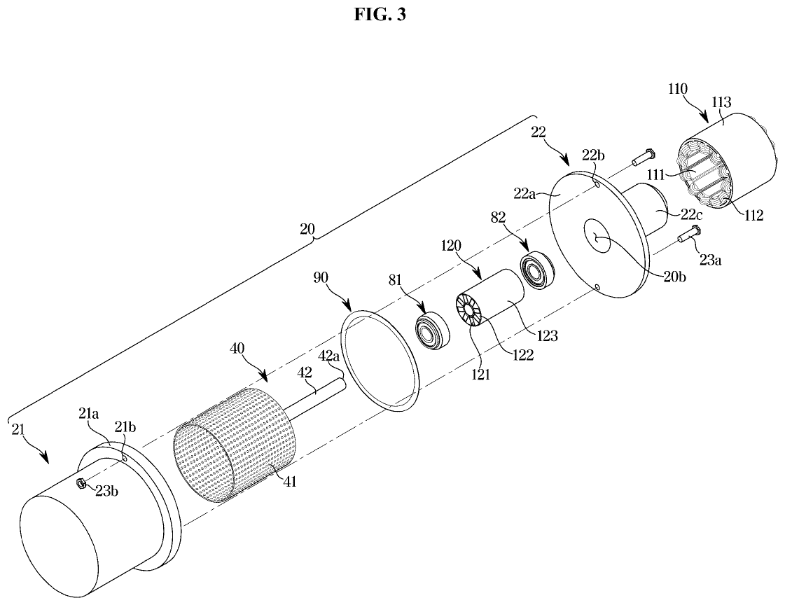

FIG. 2 illustrates the washing tub, the drum, and the drive device in the washing machine according to an embodiment. FIG. 3 illustrates the washing tub, the drum, and the drive device disassembled in the washing machine according to an embodiment.

Referring to FIGS. 2 and 3, the washing machine 1 may include the washing tub 20, the drum 40 rotatably arranged within the washing tub 20, and the drive device 100 configured to provide a rotational force to rotate the drum 40.

The washing tub 20 may be a pressure container or a pressure vessel capable of receiving carbon dioxide at high pressure.

The washing tub 20 may include a first washing tub body 21 and a second washing tub body 22. The washing tub 20 may be formed by coupling the first washing tub body 21 and the second washing tub body 22. The washing tub 20 may include a drum receiving portion 20a configured to receive a drum therein, and a rotor receiving portion 20b configured to receive a rotor 120 of the drive device 100. The first washing tub body 21 may be configured to form the drum receiving portion 20a. The second washing tub body 22 may be configured to form the rotor receiving portion 20b. A stator 110 of the drive device 100 may be arranged on an outside of the second washing tub body 22.

The first washing tub body 21 may be provided in an approximately cylindrical shape. The drum receiving portion 20a for receiving the drum 40 may be formed inside the first washing tub body 21 having an approximately cylindrical shape. The first washing tub body 21 may include a first flange 21a protruding radially from the first washing tub body 21. The first flange 21a may extend along a circumferential direction of the first washing tub body 21. The first flange 21a may be arranged at one end of the first washing tub body 21. The first flange 21a may be arranged at one end of the first washing tub body 21 that is coupled with the second washing tub body 22 so as to contact the second washing tub body 22.

A first fastening hole 21b may be formed in the first flange 21a into which a fastening member is inserted. The first fastening hole 21b may be formed by penetrating the first flange 21a in a direction perpendicular to a radial direction of the first washing tub body 21. In other words, the first fastening hole 21b may be formed by penetrating the first flange 21a in a direction parallel to a direction in which a rotating shaft 42 extends. The first fastening holes 21b may be provided in a plurality. The first flange 21a may have at least two or more first fastening holes 21b for rigidly coupling of the first washing tub body 21 and the second washing tub body 22.

The second washing tub body 22 may be provided in an approximately cylindrical shape. The second washing tub body 22 may be arranged in a cylindrical shape smaller than the first washing tub body 21. The rotor receiving portion 20a in which the rotating shaft 42 and the rotor 120 are received may be formed inside the second washing tub body 22 having a substantially cylindrical shape. The stator 110 may be arranged on the outside of the second washing tub body 22. The stator 110 may be arranged on an outer side of the second washing tub body 22 forming a side surface 22c of the washing tub 20. The stator 110 may be arranged to contact the side surface 22c of the washing tub 20 or may be arranged to have a predetermined clearance from the side surface 22c of the washing tub 20.

The second washing tub body 22 may be arranged to be coupled with the first washing tub body 21. The second washing tub body 22 may be coupled with the first washing tub body 21 to form the washing tub 20. The second washing tub body 22 may include a second flange 22a protruding radially from the second washing tub body 22 having a substantially cylindrical shape. The second flange 22a may extend along the circumferential direction of the second washing tub body 22. The second flange 22a may be arranged at one end of the second washing tub body 22. The second flange 22a may be arranged at one end of the second washing tub body 22 that is coupled with the first washing tub body 21 so as to contact the first washing tub body 21. The outer diameter of the second flange 22a may be arranged to be substantially equal to the outer diameter of the first flange 21a.

A second fastening hole 22b may be formed in the second flange 22a into which a fastening member is inserted. The second fastening hole 22b may be formed by penetrating the second flange 22a in a direction perpendicular to the radial direction of the second washing tub body 22. In other words, the second fastening hole 22b may be formed by penetrating the second flange 22a in a direction parallel to the direction in which the rotating shaft 42 extends. The second fastening holes 22b may be provided in a plurality. The number of second fastening holes 22b may correspond to that of the first fastening holes 22a. The second flange 22a may have at least two or more second fastening holes 22b for rigidly coupling of the first washing tub body 21 and the second washing tub body 22.

The first washing tub body 21 and the second washing tub body 22 may be coupled by a fastening member. The fastening member may include a first fastening member 23a and a second fastening member 23b. For example, the first fastening member 23a may include a bolt 23a, and the second fastening member 23b may include a nut. However, the fastening member is not limited thereto. Various types of fastening members may couple the first washing tub body 21 and the second washing tub body 22 through the first fastening hole 21b and the second fastening hole 22b.

The drum 40 rotatably arranged in the washing tub 20 may be formed in an approximately cylindrical shape. Laundry may be loaded into the drum 40. The drum 40 may include a plurality of drum holes 41 formed along an outer surface of the drum 40 to allow fluid to be in fluidly communication between the washing tub 20 and the drum 40. The plurality of drum holes 41 may allow carbon dioxide to be discharged from the inside of the drum 40 to the outside of the drum 40 or may be introduced into the inside of the drum 40 from the outside of the drum 40.

The first washing tub body 21 and the second washing tub body 22 may be formed of non-magnetic stainless steel (SUS). However, the material of the washing tub 20 is not limited thereto. The washing tub may be formed of a variety of materials, including SUS, as long as it may accommodate high-pressure carbon dioxide therein. However, as will be described later, the rotor 120 of the drive device 100 may be accommodated inside the washing tub 20, and the stator 110 of the drive device 100 may be arranged outside the washing tub 20. Since the rotor 120 is configured to rotate by electromagnetic interaction with the stator 110, the washing tub 20 may be configured not to include a magnetic material that interferes with the electromagnetic interaction between the rotor 120 and the stator 110.

The drive device 100 may include the stator 110 arranged outside the washing tub 20 and the rotor 120 arranged inside the washing tub.

At least a portion of the washing tub 20 may be arranged between the stator 110 and the rotor 120. In particular, a portion of the second washing tub body 22 may be arranged between the stator 110 and the rotor 120. In the following, a portion of the second washing tub body 22 arranged between the stator 110 and the rotor 120 may be referred to as the side surface 22c of the washing tub 20. The stator 110 may be arranged to surround the side surface 22c of the washing tub 20. The stator 110 may be arranged to contact the side surface 22c of the washing tub 20. Alternatively, the stator 110 may be positioned to have a predetermined gap with the side surface 22c of the washing tub 20.

The stator 110 may include an insulator 111, a coil 112 arranged to be wound on the insulator 111, and a stator cover 113 configured to cover at least a portion of the insulator 111 and the coil 112.

The rotor 120 may include a plurality of magnets 121, a magnet holder 122 configured to support the plurality of magnets 121, and a rotor cover 123 configured to cover the sides of the plurality of magnets 121 and the magnet holder 122.

The washing machine 1 may include the rotating shaft 42 connected to the drum 40 so as to rotate together with the drum 40. The rotating shaft 42 may be connected to the drive device 100 and configured to receive a rotating force from the drive device 100 to rotate the drum 40.

One end 42a of the rotating shaft 42 may be positioned inside the rotor receiving portion 20b of the washing tub 20, and the other end 42b of the rotating shaft 42 may be connected with the drum 40. The other end 42b of the rotating shaft 42 connected to the drum 40 may be positioned inside the drum receiving portion 20a. According to the present disclosure, the opposite ends 42a and 42b of the rotating shaft 42 may be positioned inside the washing tub 20, which is a pressure vessel. Accordingly, the rotating shaft 42 may not extend outside the washing tub 20 by penetrating the washing tub 20.

The conventional washing machines that perform washing using carbon dioxide include a rotating shaft penetrating the washing tub, which is a pressure vessel. Since such washing machines have a rotating shaft penetrating the washing tub, which is filled with carbon dioxide at high pressure inside, a mechanical seal has been required to seal the rotating shaft in order to prevent the carbon dioxide, which is a fluid, from leaking through a gap between the rotating shaft and the washing tub. The mechanical seal may have the disadvantage that the parts for the mechanical seal have to be replaced periodically.

The washing machine 1 according to the present disclosure may not include a mechanical seal to seal the gap between the rotating shaft and the washing tub because the rotating shaft 42, which is configured to receive a rotational force from the drive device 100 and rotate together with the drum 40, does not penetrate the washing tub 20, which is a pressure vessel. Since the rotating shaft 42 does not penetrate the washing tub 20, a mechanical seal may not be required, and thus, the washing machine 1 according to the present disclosure may be operable without periodic replacement of parts.

In order for the rotating shaft 42 to be arranged inside the washing tub 20, the stator 110 may be arranged outside the washing tub 20 and the rotor 120 may be arranged inside the washing tub 20. Accordingly, the washing machine 1 according to the present disclosure may include an internal rotor type drive device 100. The reason why the stator 110 is positioned on the outer side the washing tub 20 is because the electrical components, such as connectors and wires, may be connected to the stator 110. When the stator is positioned on the inner side of the washing tub, the wires connected to the stator may be required to pass through the washing tub, which may cause fluid leakage problems, as the rotating shaft penetrates the washing tub.

The washing machine 1 may include a bearing. According to an embodiment, the washing machine 1 may include a first bearing 81 and a second bearing 82. Alternatively, the washing machine 1 may include a single bearing that rotatably supports the rotating shaft 42 and is arranged in the rotor receiving portion 20b.

The first bearing 81 and the second bearing 82 may rotatably support the rotating shaft 42, which is arranged to rotate by receiving power from the drive device 100. The first bearing 81 and the second bearing 82 may be arranged in the rotor receiving portion 20b. According to an embodiment, the rotor 120 may be arranged between the first bearing 81 and the second bearing 82, but is not limited thereto.

The washing machine 1 may further include a sealing member 90. The sealing member 90 may be configured to seal between the first washing tub body 21 and the second washing tub body 22. The sealing member 90 may be arranged between the first flange 21a and the second flange 22a. The sealing member 90 may have an approximately annular shape.

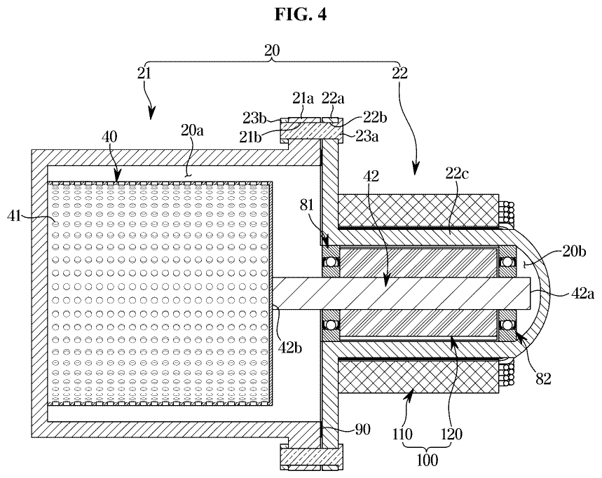

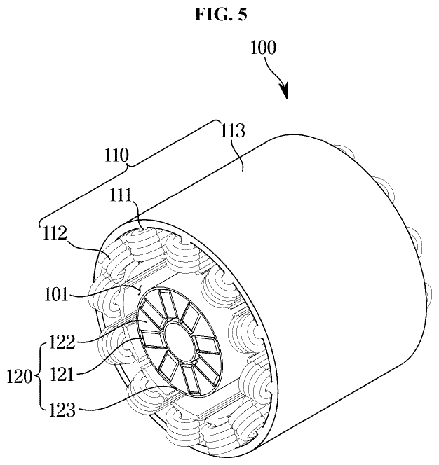

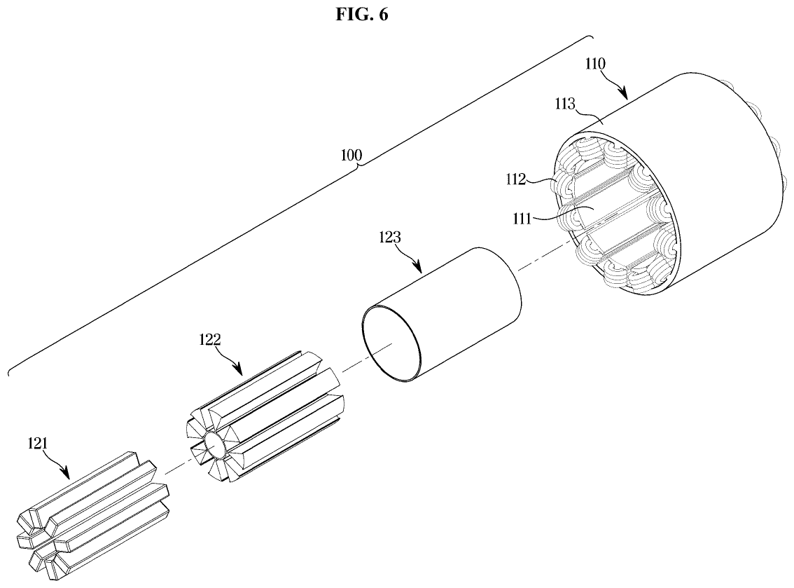

FIG. 4 is an example of a cross-section taken along A-A′ of FIG. 2. FIG. 5 is an example of the drive device in the washing machine according to an embodiment. FIG. 6 is an exploded view of the drive device shown in FIG. 5.

Referring to FIG. 4, the first bearing 81 and the second bearing 82 may each be arranged in the rotor receiving portion 20b. The rotor receiving portion 20b may have an open side connected to the drum receiving portion 20a and a closed side opposite to the open side.

The first bearing 81 may be arranged between the drum 40 and the rotor 120 to rotatably support the rotating shaft 81. The first bearing 81 may be arranged adjacent to the open side of the rotor receiving portion 20b.

The second bearing 82 may be arranged between the rotor 120 and the closed side of the rotor receiving portion 20b. The second bearing 82 may be arranged adjacent to the closed side of the rotor receiving portion 20b. However, the present disclosure is not limited thereto, and the washing machine may include only one bearing. In this case, the bearing may be arranged between the rotor and the drum, or between the rotor and the closed side of the rotor receiving portion.

Referring to FIG. 4, the sealing member 90 may extend along the circumferential direction of the first washing tub body 21 or the second washing tub body 22. The sealing member 90 may be arranged closer to the center of the first washing tub body 21 than the first fastening hole 21b. The sealing member 90 may be arranged closer to the center of the second washing tub body 22 than the second fastening hole 22b. In other words, the shortest distance from the rotating shaft 42 to the sealing member 90 may be shorter than the shortest distance from the rotating shaft 42 to the first fastening hole 21b or the second fastening hole 22b. The shortest distance from the rotating shaft 42 to the sealing member 90 may refer to a distance in a second direction perpendicular to a first direction in which the rotating shaft 42 extends from the rotating shaft 42 to the sealing member 90. With such an arrangement of the sealing member 90, the size of the outer diameters of the first flange 21a and the second flange 22a may be minimized. This is because in a case where the sealing member 90 is positioned further from the center of the washing tub 20 than the first fastening hole 21b and the second fastening hole 22b, the outer diameters of the first flange 21a and the second flange 22a may need to be increased in order to position the sealing member 90.

Referring to FIG. 5, an air gap 101 may be provided between the stator 110 and the rotor 120 of the drive device 100. In the air gap 101, the side surface 22c of the washing tub 20 may be positioned. In other words, the rotor 120 may be positioned on the inner side of the side surface 22c of the washing tub 20, and the stator 110 may be positioned on the outer side of the side surface 22c of the washing tub 20.

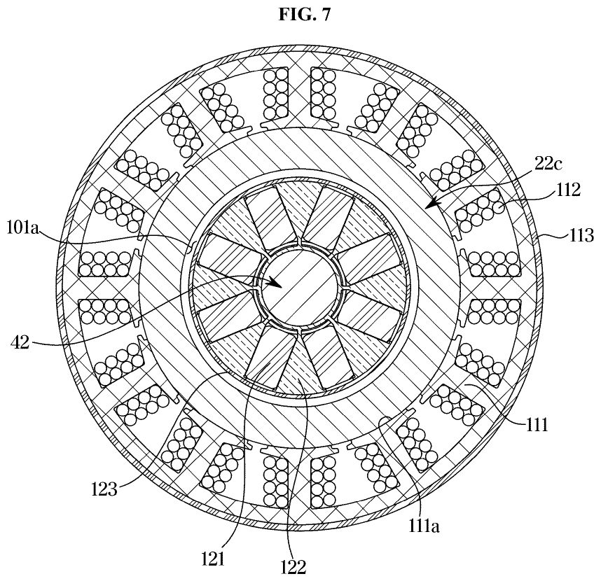

FIG. 7 is an example of a cross-section taken along B-B′ of FIG. 2.

Referring to FIG. 7, the drive device 100 of the washing machine 1 according to an embodiment may include the stator 110 arranged to contact the side surface 22c of the washing tub 20. The stator 110 may be arranged to contact the side surface 22c of the washing tub 20. Accordingly, there may be no gap between the stator 110 and the side surface 22c of the washing tub 20. Since the stator 110, unlike the rotor 120, is not a rotating configuration, the stator 110 may be arranged to contact the side surface 22c of the washing tub 20 in order to reduce the gap between the stator 110 and the rotor 120.

A first gap 101a may be formed between the rotor 120 and the side surface 22c of the washing tub 20. Since the rotor 120 rotates together with the rotating shaft 42, a predetermined first gap 101a may be required between the rotor 120 and the side surface 22c of the washing tub 20 to prevent the rotor 120 from contacting the side surface 22c of the washing tub 20 during rotation of the rotor 120.

Referring to FIG. 7, the air gap between the stator 110 and the rotor 120 may be the sum of the first gap 101a formed between the rotor 120 and the side surface 22c of the washing tub 20 and the thickness of the side surface 22c of the washing tub 20. Since no gap is formed between the stator 110 and the side surface 22c of the washing tub 20, the air gap between the stator 110 and the rotor 120 may be minimized.

In a conventional washing machine, where no separate configuration is positioned between the stator and the rotor, such as a side surface of a washing tub, the air gap between the stator and the rotor may be quite small. For example, in a conventional washing machine, the air gap between the stator and the rotor may be about 1 mm or less. In such a washing machine, the rotor of the drive device may include a ferrite magnet with a relatively low magnetic flux density.

In the washing machine 1 according to the present disclosure, the air gap between the stator 110 and the rotor 120 may be larger than that of a conventional washing machine because the side surface 22c of the washing tub 20 is positioned between the stator 110 and the rotor 120, as described above. For example, the air gap between the stator 110 and the rotor 120 may be 3 to 5 mm. As the air gap between the stator 110 and the rotor 120 increases, the output of the drive device 100 may be reduced. To compensate for such reduced output, the drive device 100 according to the present disclosure may include a neodymium (Nd) magnet having a relatively high magnetic flux density.

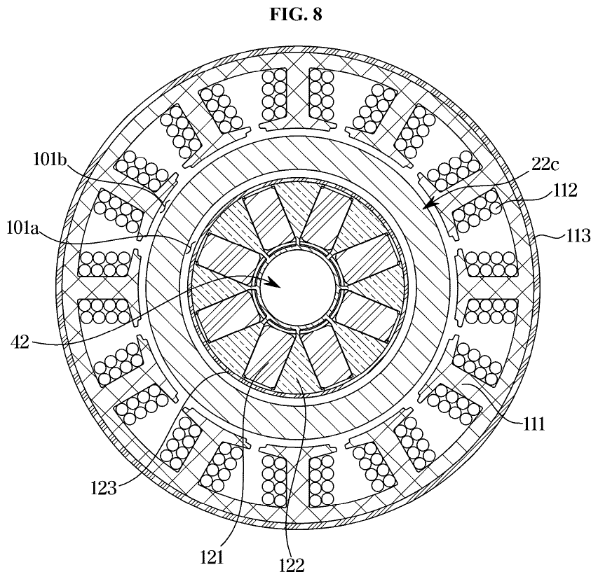

FIG. 8 is an example of a cross-section taken along B-B′ of FIG. 2.

Referring to FIG. 8, the drive device 100 of the washing machine 1 according to an embodiment may include the stator 110 that is positioned at a predetermined distance from the side surface 22c of the washing tub 20. A second gap 101b may be formed between the stator 110 and the side surface 22c of the washing tub 20. Since the stator 110, unlike the rotor 120, is not a rotating configuration, the second gap 101b formed between the stator 110 and the side surface 22c of the washing tub 20 may be formed to be smaller than the first gap 101a formed between the rotor 120 and the side surface 22c of the washing tub 20.

The first gap 101a may be formed between the rotor 120 and the side surface 22c of the washing tub 20. Since the rotor 120 rotates together with the rotating shaft 42, the predetermined first gap 101a may be required between the rotor 120 and the side surface 22c of the washing tub 20 to prevent the rotor 120 from contacting the side surface 22c of the washing tub 20 during the rotation of the rotor 120.

Referring to FIG. 8, the air gap between the stator 110 and the rotor 120 may be the sum of the first gap 101a formed between the rotor 120 and the side surface 22c of the washing tub 20, the thickness of the side surface 22c of the washing tub 20, and the second gap 101b formed between the side surface 22c of the washing tub 20 and the stator 110.

In the washing machine 1 according to the present disclosure, the side surface 22c of the washing tub 20 may be arranged between the stator 110 and the rotor 120, so that the air gap between the stator 110 and the rotor 120 may be larger than in a conventional washing machine. As the air gap between the stator 110 and the rotor 120 increases, the output of the drive device 100 may be reduced. To compensate for such reduced output, the drive device 100 according to the present disclosure may include an Nd magnet having a relatively high magnetic flux density.

According to an embodiment, the washing machine may include a washing tub configured to wash laundry using carbon dioxide and forming a sealed internal space to maintain the pressure of the carbon dioxide received in the washing tub, a drum rotatably arranged within the washing tub, a drive device configured to provide a rotational force to rotate the drum, and a rotating shaft connected to the drive device and the drum, respectively, and configured to receive the rotational force from the drive device to rotate the drum. The drive device may include a stator arranged outside the washing tub, and a rotor configured to rotate by electromagnetic interaction with the stator and coupled to the rotating shaft inside the washing tub.

In order for the rotating shaft to not penetrate the washing tub, opposite ends of the rotating shaft may be arranged inside the washing tub.

One end of the rotating shaft may be connected to the drum.

The other end of the rotating shaft may be arranged inside the washing tub.

The washing tank may include a drum receiving portion enabled to receive the drum, and a rotor receiving portion enabled to receive the rotor and at least a portion of the rotating shaft, the rotor receiving portion having one side open (also referred to as an open side) connected to the drum receiving portion and the other side closed (also referred to as a closed side).

The washing machine may further include a bearing configured to rotatably support the rotating shaft and arranged inside the rotor receiving portion.

The bearing may include a first bearing arranged adjacent to the one side of the rotor receiving portion so as to be positioned between the rotor and the drum, and a second bearing arranged adjacent to the other side of the rotor receiving portion so as to be positioned between the other side of the rotor receiving portion and the rotor.

The stator may be arranged to contact an outer side of the rotor receiving portion to reduce a gap with the rotor in a second direction perpendicular to a first direction in which the rotating shaft extends.

The rotor may be spaced apart from the rotor receiving portion by a predetermined gap in the second direction to prevent the rotor from contacting an inner side of the rotor receiving portion as the rotor rotates.

The washing tub may include a first washing tub body configured to form the drum receiving portion, and a second washing tub body configured to form the rotor receiving portion.

The first washing tub body and the second washing tub body may be coupled by a fastening member to form the washing tub.

The first washing tub body may include a first flange protruding from the first washing tub body in a radial direction of the first washing tub body and including a first fastening hole.

The second washing tub body may include a second flange protruding from the second washing tub body in a radial direction of the second washing tub body and including a second fastening hole corresponding to the first fastening hole.

The fastening member may couple the first washing tub body and the second washing tub body by penetrating the first fastening hole and the second fastening hole in a direction parallel to the first direction in which the rotating shaft extends.

The washing machine may further include a sealing member arranged between the first flange and the second flange to seal between the first washing tub body and the second washing tub body.

The sealing member may extend along a circumferential direction of the first washing tub body or the second washing tub body.

A distance from the rotating shaft to the sealing member in a second direction perpendicular to a first direction may be shorter than a distance from the rotating shaft to the fastening member in the second direction.

The rotor may include a plurality of magnets spaced apart from each other along a circumferential direction of the rotating shaft.

Each of the plurality of magnets may be configured to include Nd.

The washing tub may be configured to include SUS.

According to various embodiments of the present disclosure, the washing machine that may eliminate the need for the mechanical seal may be provided by arranging the rotor inside the washing tub, which is the pressure vessel, and the stator outside the washing tub.

According to various embodiments of the present disclosure, the washing machine that may rotate the drum inside the washing tub without including the mechanical seal may be provided by arranging the stator outside the washing tub and the rotor inside the washing tub.

While the present disclosure has been particularly described with reference to exemplary embodiments, it should be understood by those of skilled in the art that various changes in form and details may be made without departing from the spirit and scope of the present disclosure.

1. A washing machine, comprising:
a washing tub forming a sealable internal space in which carbon dioxide is receivable and configured so that, with the carbon dioxide received in the internal space and the internal space sealed, a pressure of the carbon dioxide is maintained;
a rotatable drum in the internal space and configured to accommodate laundry to be washed with the received carbon dioxide;
a rotatable shaft in the internal space and connected to the drum; and
a drive device including:
a stator outside the washing tub, and
a rotor in the internal space, coupled to the shaft, and configured so that, with the carbon dioxide received in the internal space and the internal space sealed, electromagnetic interaction between the rotor and the stator causes the rotor to rotate thereby rotating the shaft and the drum to wash the laundry accommodated in the drum with the received carbon dioxide.

2. The washing machine of claim 1, wherein opposite ends of the shaft are within the internal space so that the shaft does not penetrate through the washing tub.

3. The washing machine of claim 1, wherein a first end of the shaft is connected to the drum, and a second end of the shaft is within the washing tub.

4. The washing machine of claim 1, wherein
the washing tub includes:
a drum receiving portion configured to receive the drum, and
a rotor receiving portion in which the rotor and at least a portion of the shaft is received, and having a first side that is open and connected to the drum receiving portion and a second side that is closed.

5. The washing machine of claim 4, further comprising:
a bearing within the rotor receiving portion and rotatably supporting the shaft.

6. The washing machine of claim 5, wherein
the bearing includes:
a first bearing adjacent to the first side of the rotor receiving portion and between the rotor and the drum, and
a second bearing adjacent to the second side of the rotor receiving portion and between the second side of the rotor receiving portion and the rotor.

7. The washing machine of claim 4, wherein the stator contacts an outer surface of the rotor receiving portion so that a gap between the rotor and the stator in a direction perpendicular to a direction in which the shaft extends is reduced.

8. The washing machine of claim 7, wherein the rotor is spaced apart from the rotor receiving portion by a predetermined gap in the direction perpendicular to the direction in which the shaft extends so that the rotor is prevented from contacting an inner surface of the rotor receiving portion as the rotor is rotated.

9. The washing machine of claim 4, wherein
the washing tub includes:
a first washing tub body forming the drum receiving portion, and
a second washing tub body forming the rotor receiving portion, and
the first washing tub body and the second washing tub body are coupled by a fastening member to form the washing tub.

10. The washing machine of claim 9, wherein
the first washing tub body includes a first flange protruding radially from the first washing tub body and including a first fastening hole, and
the second washing tub body includes a second flange protruding radially from the second washing tub body and including a second fastening hole corresponding to the first fastening hole, and
the fastening member penetrates the first fastening hole and the second fastening hole in a direction parallel to the direction in which the shaft extends to thereby couple the first washing tub body and the second washing tub body.

11. The washing machine of claim 10, further comprising:
a sealing member between the first flange and the second flange and providing a seal between the first washing tub body and the second washing tub body.

12. The washing machine of claim 11, wherein
the sealing member extends along a circumferential direction of the first washing tub body and/or the second washing tub body, and
a distance from the shaft to the sealing member in a direction perpendicular to a direction in which the shaft extends is shorter than a distance from the shaft to the fastening member in the direction perpendicular to the direction in which the shaft extends.

13. The washing machine of claim 1, wherein
the rotor includes a plurality of magnets spaced apart from each other along a circumferential direction of the shaft, and
each magnet of the plurality of magnets includes neodymium (Nd).

14. The washing machine of claim 1. wherein the washing tub includes stainless steel (SUS).
